(19) United States
(12) Patent Application Publication
(10) Pub. No.: US 2013/0088108 A1
(43) Pub. Date: Apr. 11, 2013

(54) ELECTRIC MOTOR

(71) Applicant: Brose Fahrzeugteile GMBH & Co. Kommanditges, Wuerzburg (DE)

(72) Inventors: Peter KLINGLER, Neubrunn (DE); Juergen NEIDHARDT, Marktbreit (DE)

(73) Assignee: BROSE FAHRZEUGTEILE GMBH & CO. KOMMANDITGESELLSCHAFT, Wuerzburg (DE)

(21) Appl. No.: 13/687,649

(22) Filed: Nov. 28, 2012

Related U.S. Application Data
(63) Continuation of application No. PCT/EP2011/001500, filed on Mar. 25, 2011.

(30) Foreign Application Priority Data
May 28, 2010 (DE) 20 2010 007 342.1

(51) Int. Cl. H02K 11/02

(52) U.S. Cl. CPC H02K 11/022
USPC 310/72; 310/418

(57) ABSTRACT

An electric motor contains an electrically conductive motor housing which encloses a stator, a rotor, and a commutator ground by a brush system and which has an opening for a motor shaft on one side. The brush system includes a pot-type support housing which closes the opening of the motor housing, is made of electrically conductive plastic, and has a central shaft opening to allow the motor shaft to pass there-through.

### CROSS-REFERENCE TO RELATED APPLICATION

This application is a continuation, under 35 U.S.C. §120, of copending international application No. PCT/EP2011/001500, filed Mar. 25, 2011, which designated the United States; this application also claims the priority, under 35 U.S.C. §119, of German patent application No. DE 20 2010 007 342.1, filed May 28, 2010; the prior applications are herewith incorporated by reference in their entireties.

### BACKGROUND OF THE INVENTION

### Field of the Invention

The invention relates to an electric motor having an electrically conductive motor housing which encloses a stator, a rotor and a commutator, which is ground by a brush system, and which has a housing opening for a motor shaft on one side.

Electric motors which are used in drives for actuating elements of a motor vehicle and which are operated using direct current in particular have a mechanical commutator. The commutator laminations of the commutator are connected to the armature windings of the rotor and establish sliding contact with brushes of a brush system. The commutator or the laminations of the commutator are connected to the motor shaft in a rotationally fixed manner, with the result that rotation of the motor shaft results in the armature windings being connected to the voltage source by the ground brush system with the correct phase.

The electromechanical commutation results in electromagnetic waves in the radio-frequency range which are generated by the electric motor and emitted to the surrounding area being produced. This leads to interference (radio interference) in technical devices in the area surrounding the electric motor, this conflicting with the requirement for electromagnetic compatibility (EMC) that such electromagnetic interference be suppressed. In order to establish the electromagnetic compatibility of an electric motor of this kind, it is known to equip the brush system with interference-suppression elements, in particular with interference-suppression inductors and/or interference-suppression capacitors. However, these measures are often not sufficient to ensure adequate electromagnetic compatibility.

Published, non-prosecuted German patent application DE 10 2007 058 089 A1 discloses the further-reaching interference-suppression measures of closing the housing opening of the motor housing with a cover-like shield which is composed of a metallically conductive material, for example a conductive plastic. The cover-like shield, as an additional component to the brush support which is inserted into the motor housing, is complicated in terms of production and in terms of assembly and requires the provision of additional installation space. This conflicts in an undesirable manner with the need for further reducing in size electric motors of this kind.

Published, non-prosecuted German patent application DE 10 2008 001 047 A1 discloses, in the case of an electric motor, connecting a support element to the motor housing of the electric motor. The recesses in the support element for accommodating interference-suppression elements are moved to outside the motor housing as part of the process of miniaturization of the electric motor. The interference-suppression elements are integrated in a plug connection which is provided there, while a brush support of the support element accommodates only the brushes. The support element or parts of the support element have an electrically conductive material or are completely or partially coated with an electrically conductive material. By moving the interference-suppression elements to outside the motor housing, the support element has an undesirably high volume, in particular in the region of the plug connector.

### SUMMARY OF THE INVENTION

It is accordingly an object of the invention to provide an electric motor which overcomes the above-mentioned disadvantages of the prior art devices of this general type, which is reliably shielded against electromagnetic interference.

With the foregoing and other objects in view there is provided, in accordance with the invention an electric motor. The electric motor contains a stator, a rotor, a commutator, a brush system grounding the commutator, a shaft and an electrically conductive motor housing enclosing the stator, the rotor and the commutator. The electrically conductive motor housing has a housing opening for the motor shaft on one side. The brush system has a pot-shaped support housing covering the housing opening and is composed of an electrically conductive plastic and has a central shaft opening for the motor shaft to pass through.

To this end, the brush system of the electric motor has a pot-like support housing which closes the housing opening in the motor housing and is composed of electrically conductive plastic and has a central shaft opening for the motor shaft to pass through. The pot-like support housing suitably contains a pot base which is provided with the central shaft opening and a pot wall which is integrally formed on the pot base and is circumferentially at least substantially closed.

In the assembled state, the pot wall of the support housing bears against the housing inner wall in the region of the housing opening in the motor housing, while the pot base virtually completely covers the housing opening in the motor housing. To this end, the pot base suitably projects beyond the pot wall so as to form a supporting collar by way of which the support housing rests on the opening edge of the housing opening or bears against the opening edge of the motor housing and is suitably aligned with the opening edge.

Therefore, in the assembled state, the pot or housing wall of the conductive support housing projects into the motor housing, while the support housing base or pot base covers the housing opening in the motor housing so as to form only the central shaft opening for the motor shaft. In this case, the clear width (inside or opening diameter) of the central shaft opening is of a size such that the motor shaft passes through the shaft opening with the smallest possible amount of play or annular gap. The support housing which rests in the motor housing by way of its housing wall expediently has a housing cuff which surrounds the shaft opening and extends from the housing base of the support housing suitably both into the motor housing and to the outside on the opposite base side.

An at least slight accommodation space for accommodating interference-suppression elements and connection contacts is formed between the opening cuff and the housing wall of the support housing which suitably bears in an interlocking manner against the motor housing. A number of housing contours for accommodating or holding the interference-suppression elements and also housing pockets, which issue into the shaft opening, for the brushes of the brush system are formed in the region of the support housing. In addition, plug bases for pressing in, pushing in and/or piercing motor and/or connection contacts for making contact with the interference-suppression elements are formed in the annular housing space in the support housing. Further contact elements for making contact with the interference-suppression elements, in particular the interference-suppression capacitors, by way of the metallic motor housing at the housing inner wall thereof are suitably fitted, in particular clamped or latched, onto the housing wall of the support housing.

In an advantageous refinement, a plug contact housing, which is likewise composed of electrically conductive plastic, as a plug connector for making contact with the motor and also a signal and/or control electronics system, which may be present, are held on the support housing. The plug contact housing is fitted—possibly in addition to existing signal and/or control contacts—with motor connection contacts which, for their part, are electrically conductively connected to the brushes of the brush system by the interference-suppression elements which are arranged within the support housing—and there in the region around the shaft bushing for the motor shaft. The plug connector which is formed as a result is particularly space-saving and to this end bears suitably directly against the motor housing and consequently projects only correspondingly slightly beyond the motor housing.

In order to hold the support housing on the motor housing, two latching elements are integrally formed on the support housing suitably on diagonally opposite housing sides. The latching elements latch to corresponding latching contours of the motor housing in the assembled state. In addition to these latching contours, a number of holding lugs, preferably two holding lugs which are once again situated diagonally opposite one another, are integrally formed on the motor housing, suitably in the region of the housing opening in the motor housing. The holding lugs, like the latching contours, expediently project radially beyond the housing opening in the motor housing. The holding lugs are used to attach the motor housing to a gear mechanism housing, for example of a worm gear mechanism, which is particularly composed of plastic. A worm gear that is mounted in the gear mechanism housing meshes with a worm which is supported on that shaft end of the motor shaft which is opposite the rotor on the gear mechanism side and which projects out of the motor housing via the shaft opening in the support housing and into the gear mechanism housing.

A conductive polymer is suitably provided as the electrically conductive plastic both for the support housing and for the plug contact housing of the plug connection. The electrical conductivity of the plastic used can be adjusted by correspondingly doping the polymer, in particular in such a way that the support housing or the plug contact housing, despite having a high impedance, for example in the region of 100 ohms, is sufficiently conductive for adequate shielding of radio-frequency interference radiation. The at least slightly electrically conductive support housing which is inserted into the metallic motor housing enables reliable shielding of the electric motor and therefore the required electromagnetic compatibility of the electric motor with a simple, reliable and particularly compact design.

Other features which are considered as characteristic for the invention are set forth in the appended claims.

Although the invention is illustrated and described herein as embodied in an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal sectional view through an EMC-shielded electric motor with a support housing inserted into a motor housing of the electric motor according to the invention;

FIG. 2 is a perspective, side view of the electric motor according to FIG. 1;

FIG. 3 is a perspective, end view of the electric motor in the support housing according to FIG. 1;

FIG. 4 is a perspective view of a base of the support housing; and

FIG. 5 is a perspective view of the support housing according to FIG. 4 in a view of an inside of the support housing with interference-suppression elements and connection contacts inserted.

### DETAILED DESCRIPTION OF THE INVENTION

Corresponding parts are provided with the same reference symbols in all the figures.

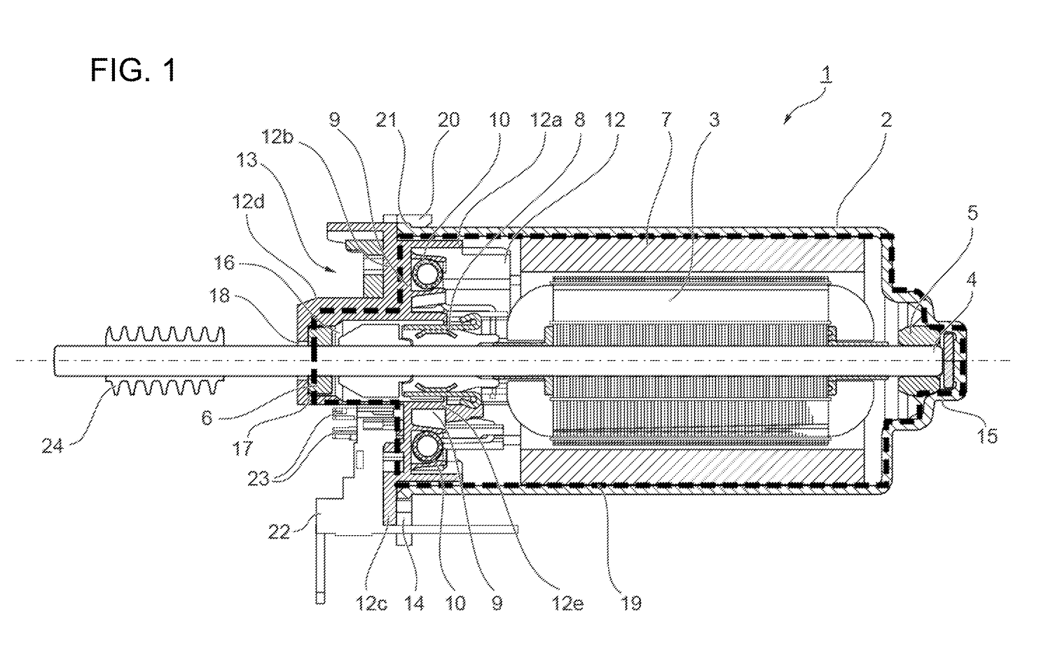

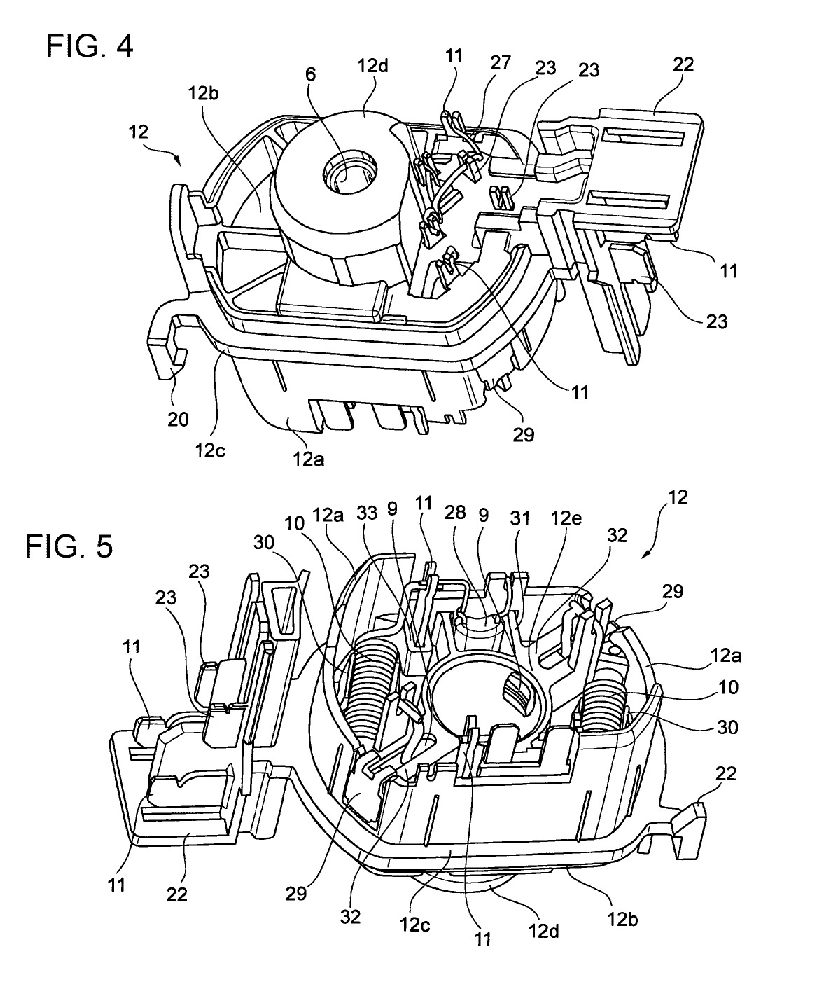

Referring now to the figures of the drawing in detail and first, particularly, to FIG. 1 thereof, there is shown a sectional illustration of a virtually completely shielded and therefore electromagnetically compatible electric motor 1 having a metallic, and therefore electrically conductive, motor housing 2 which is produced from a sheet metal material, for example, using a deep-drawing process. A motor shaft 4 which supports a rotor 3 is mounted in a rotary manner in a rotor-side cup-and-ball bearing 5 and in a gear mechanism-side sliding or sintered bearing 6 within the motor housing 2. Permanent magnets 7 which are held in the motor housing 2 in a stationary manner form the stator of the electric motor 1. A commutator 8 with commutator laminations is arranged on the motor shaft 4 in a manner fixed to the shaft between the rotor 3 and the sliding bearing 6. The commutator 8 is ground by carbon brushes 9 of a brush system which contains two brushes 9 in the exemplary embodiment. Interference-suppression inductors 10 are connected to the brushes 9, motor contacts 11 (FIGS. 3 and 4; not shown in FIG. 1) making contact with the interference-suppression inductors.

The brush system 9 is disposed in a pot-like support housing 12 which is composed of a conductive plastic and is inserted into the motor housing 2 in an interlocking manner by way of its housing or pot wall 12a via a housing opening 13 of the motor housing. The housing or pot base 12b of the support housing 12 virtually completely covers the housing opening 13 in the motor housing 2. To this end, the housing base 12b projects beyond the housing opening 13 in the motor housing 2 by way of a supporting collar 12c by way of which the support housing 12 is seated on an opening edge 14 of the motor housing 2.

On that housing side of the electric motor which is situated opposite the support housing 12, the motor housing 2 is closed at the base so as to form an end plate 15 in which the cup-and-ball bearing 5 is situated and held. In the region of a central shaft opening 16 which is provided in the support housing 12, the central shaft opening is surrounded by a housing cuff 12d which projects beyond the housing base 12b. The housing cuff 12d projects into the inside of the support housing 12 by way of a corresponding cuff section 12e.

Outside the housing, an annular or bearing groove 17 for accommodating and holding the sliding or sintered bearing 6 is made in the housing cuff 12d. The motor shaft 4 which projects out of the support housing 12 on the base side via the central shaft opening 16 closes the motor housing 2, with the support housing 12 inserted, as completely as possible so as to form an annular gap 18 which is as small as possible. Therefore, a shield 19, which is correspondingly virtually completely closed and is indicated by dashed lines, for preventing electromagnetic radiation escaping from the electric motor 1, and therefore a shielding function which ensures electromagnetic compatibility, is produced.

A latching hook 20 is integrally formed on the support housing 12 on opposite housing sides in each case, only one latching hook 20 being shown in FIG. 1, the latching hook engaging behind a corresponding latching contour 21 on the opening edge 14 of the motor housing 2 for a reliable latching connection between the support housing 12 and the motor housing 2 in the assembled state.

A plug contact housing 22 is mounted on the support housing 12 and firmly connected to the support housing 12. The plug contact housing is fitted with the motor contacts 11 (FIGS. 4 and 5; not shown in FIG. 1) and further connection contacts 23. The plug contact housing 22 is likewise composed of an electrically conductive plastic.

At the shaft end, the motor shaft 4 is fitted with a worm 24 which, in a manner which is not illustrated in any detail, projects into a gear mechanism housing, which is connected to the motor housing 2, and there meshes with a worm gear of a worm gear mechanism. In this embodiment, the electric motor 1 is provided for a drive of an actuating element, for example a window winder, a seat adjustment device, a sliding roof or the like, of a motor vehicle and is particularly suitable for this.

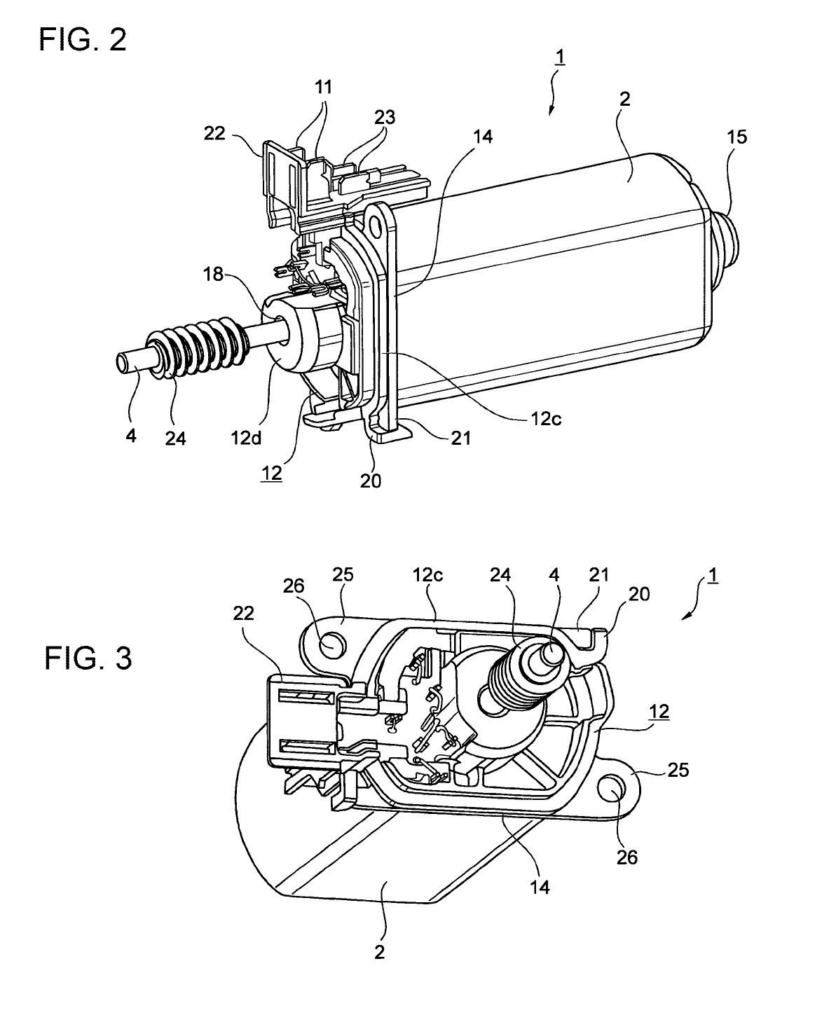

FIGS. 2 and 3 show the electric motor 1, with the motor housing 2 closed by the support housing 12, in different perspective views. The figures show the latching contours 21 at the opening edge 14 of the motor housing 2, the support housing 12 being latched to the latching contours by its latching elements 20. In addition, radially protruding holding lugs 25 with passage bores 26 are integrally formed on the opening edge 14 of the motor housing 2, the passage bores being intended to be used for screw connection to the non-illustrated gear mechanism housing.

FIGS. 4 and 5 show the pot-like support housing 12 in different perspective views. FIG. 4 shows the housing cuff 12d which is raised at the base and has an inserted sliding or sintered bearing 6. The motor contacts 11 which are routed out of the plug contact housing 22 of the plug connector 11, 22, 23 via the base of the support housing 12 are also shown. Furthermore, the further connection contacts 23 project out of the support housing 12 and beyond the plug contact housing 22 on the base side there. The motor contacts 11 and also the connection contacts 23 are connected to one another via lines 27. These connection lines 27 belong to or lead to interference-suppression elements in the form of the inductor coils 10 and also of one or two interference-suppression capacitors 28 and to further contacts 29. The contacts are mounted on the pot wall 12a of the support housing 12 on diagonally opposite housing sides and, in the assembled state, establish an electrically conductive connection to the metallic motor housing 2 as a result of butting against the inner wall of the motor housing 2 so as to make contact.

The view of the inside of the support housing 12 shown in FIG. 5 shows a number of housing contours 30 in the form of holding lugs for holding the interference-suppression inductors 10, which holding lugs are integrally formed on the pot base 12b. In addition, housing pockets 31 for accommodating the or each interference-suppression capacitor 28 are formed in the support housing 12 on the inside of the housing. Housing pockets 32 which are likewise formed in the support housing 12 are used to accommodate the brushes 9 of the brush system. Furthermore, plug bases 33 for leading the motor contacts into the support housing 12 are integrally formed in the support housing 12 on the inside of the housing.

The interference-suppression elements 10, 28 are arranged so as to be as space-saving as possible and preferably as symmetrical to one another and to the shaft opening 16 within the support housing 12 as possible. The axially extending, circumferentially closed pot wall 12a which is integrally formed on the pot base 12b encloses so as to form an accommodation space, which is sufficient for accommodating the interference-suppression elements 10, 28 and introducing the motor contacts 11 but is of as small a size as possible, and also the shaft opening 16 together with its housing cuff 12d which projects into the support housing 12.

### LIST OF REFERENCE SYMBOLS

1 Electric motor
2 Motor housing
3 Rotor
4 Motor shaft
5 Cup-and-ball bearing
6 Sliding/sintered bearing
7 Permanent magnet/stator
8 Commutator
9 Brush/brush system
10 Interference-suppression inductor
11 Motor contact
12 Support housing
12a Housing/pot wall
12b Housing/pot base
12c Supporting collar
12d Housing cuff
12e Cuff section
13 Housing opening
14 Opening edge
15 End plate
16 Shaft opening
17 Annular/bearing groove
18 Annular gap
19 Shield
20 Latching hook
21 Latching contour
22 Plug contact housing
23 Connection contact
24 Worm
25 Holding lug
26 Passage bore
27 Line
28 Interference-suppression capacitor
29 Contact
30 Housing contour/holding lug
31 Housing pocket
32 Housing pocket
33 Plug base

1. An electric motor, comprising:
a stator;
a rotor;
a commutator;
a brush system grounding said commutator;
a shaft;
an electrically conductive motor housing enclosing said stator, said rotor and said commutator, said electrically conductive motor housing having a housing opening formed therein for said motor shaft on one side; and
said brush system having a pot-shaped support housing covering said housing opening and composed of an electrically conductive plastic and having a central shaft opening formed therein for said motor shaft to pass through.

2. The electric motor according to claim 1, wherein said pot-shaped support housing has a housing base, which has said central shaft opening formed therein, and a housing wall, integrally formed on said housing base and is circumferentially closed, with said housing wall bearing against an housing inner wall of said electrically conductive motor housing in a region of said housing opening, and said housing base covering said housing opening of said electrically conductive motor housing.

3. The electric motor according to claim 2, wherein said housing base projects beyond said housing wall so as to form a supporting collar by way of which said pot-shaped support housing bears against an opening edge of said housing opening in said electrically conductive motor housing.

4. The electric motor according to claim 1,
wherein said electrically conductive motor housing has corresponding latching contours; and
further comprising at least two latching elements, which are situated opposite one another, for latching to said corresponding latching contours of said electrically conductive motor housing, are integrally formed on said pot-shaped support housing.

5. The electric motor according to claim 1,
further comprising interference-suppression elements;
further comprising plug bases for motor contacts;
wherein said brush system has brushes; and
wherein said pot-shaped support housing has a housing receptacle with a number of housing contours for accommodating or holding said interference-suppression elements, said housing receptacle further having housing pockets for said brushes of said brush system and said plug bases for the motor contacts, said housing receptacle surrounding said central shaft opening.

6. The electric motor according to claim 1, further comprising a plug contact housing composed of an electrically conductive plastic and having at least one of motor contacts or connection contacts, said plug contact housing held on said pot-shaped support housing.

7. The electric motor according to claim 1, further comprising:
a shaft bearing; and
a housing cuff integrally formed on said pot-shaped support housing, said housing cuff raised at a base and surrounding said central shaft opening and having an inner-wall bearing groove formed therein for said shaft bearing.

8. The electric motor according to claim 1, wherein said electrically conductive motor housing has, at said housing opening which is closed by said pot-shaped support housing, a number of holding lugs for attachment to a gear mechanism housing which accommodates a gear mechanism worm which is supported by said motor shaft at a shaft end.

9. The electric motor according to claim 5, wherein said interference-suppression elements are selected from the group consisting of interference-suppression inductors and interference-suppression capacitors.
